(19) United States
(12) Patent Application Publication
(10) Pub. No.: US 2006/0272997 A1
(43) Pub. Date: Dec. 7, 2006

(54) Reverse osmosis filtering assembly

(76) Inventor: Hsin-Fa Liu, Taipei City (TW)

Correspondence Address: LEONG C LEI, PMB # 1008, 1867 YGNACIO VALLEY ROAD, WALNUT CREEK, CA, 94598, US

(21) Appl. No.: 11/144,763

(22) Filed: Jun. 6, 2005

(51) Int. Cl. B01D 63/00

(52) U.S. Cl. 210/321.6; 210/435; 210/497.01

(57) ABSTRACT

A filtering assembly for the reverse osmosis water treatment system is disclosed herein. The filtering assembly encloses the membrane unit in an air-tight space formed by a membrane unit cover and a membrane unit housing, both of which could be screwed together and separated apart easily by an ordinary person without using special tools. After the membrane unit is replaced, the original membrane unit cover and housing are re-used to house the new membrane unit. The filtering assembly arranges its tubular connectors for the pipelines at various vertical and horizontal locations so that their connections wouldn't interfere with each other. Additionally, together with the design of separate membrane unit cover and housing, the pipelines could be installed only once and the replacement of the membrane unit requires no disconnecting and re-connecting the pipelines.

### BACKGROUND OF THE INVENTION

(a) Technical Field of the Invention

The present invention generally relates to reverse osmosis water treatment systems, and more particularly to the filtering assembly of a reverse osmosis water treatment system whose membrane unit could be replaced easily and economically.

(b) Description of the Prior Art

Reverse osmosis is the most popular water purification technique in recent years. For a reverse osmosis water treatment system, the membrane unit is the most critical component as it is directly related the sanitation and safety of the purified water. The membrane unit therefore requires periodical examination and replacement.

FIG. 1 is a perspective view showing the filtering assembly of a conventional reverse osmosis water treatment system. As illustrated, the filtering assembly A1 has a molded plastic housing A2 with a reverse osmosis membrane unit (not shown) sealed inside. When the time comes for replacing the membrane unit, the plastic housing A2 has to be thrown away together with the membrane unit, causing unnecessary waste and burden to the user and the environment as well. The replacement process also involves disconnecting and re-connecting the pipeline A3, which usually requires a skilled workman using wrenches and pliers. In addition, the periodical handling of the pipeline A3 also increases its chance of leakage. Therefore, there is a need for a more convenient and economical filtering assembly for the reverse osmosis water treatment system.

### SUMMARY OF THE INVENTION

The primary purpose of the present invention is to provide a filtering assembly for the reverse osmosis water treatment system. A major objective of the filtering assembly is that its membrane unit could be replaced independently and conveniently.

To achieve this objective, the filtering assembly encloses the membrane unit in an air-tight space formed by a membrane unit cover and a membrane unit housing, both of which could be screwed together and separated apart easily. The assembly and disassembly of the membrane unit cover and housing therefore could be conducted repeatedly by an ordinary person without using special tools. After the membrane unit is replaced, the original membrane unit cover and housing are re-used to house the new membrane unit.

Another objective of the filtering assembly is that the arrangement of its pipelines should facilitate the installation of the filtering assembly and the replacement of the membrane unit. To achieve the objective, the filtering assembly arranges its tubular connectors for the pipelines at various vertical and horizontal locations so that their connections wouldn't interfere with each other. Additionally, together with the present invention's design of separate membrane unit cover and housing, the pipelines could be installed only once and the replacement of the membrane unit requires no disconnecting and re-connecting the pipelines.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing the filtering assembly of a conventional reverse osmosis water treatment system.

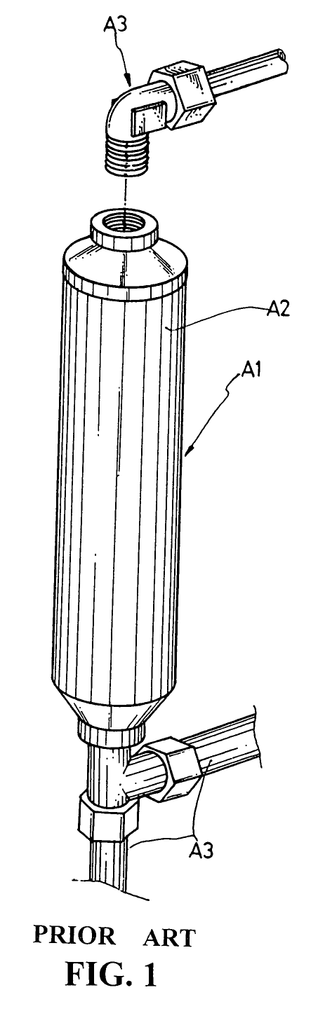

FIG. 2 is a perspective view showing the outlook of a filtering assembly according to an embodiment of the present invention.

FIG. 3 is a perspective explosion view showing the various components of the filtering assembly of FIG. 2.

FIG. 4 is a top view showing a membrane unit cover according to another embodiment of the present invention.

FIG. 5 is a sectional view showing the internal of the filtering assembly of FIG. 2.

FIG. 6 is a perspective view showing the outlook of a filtering assembly according to another embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

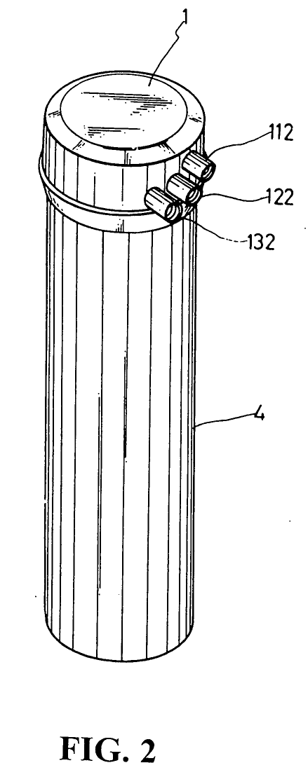

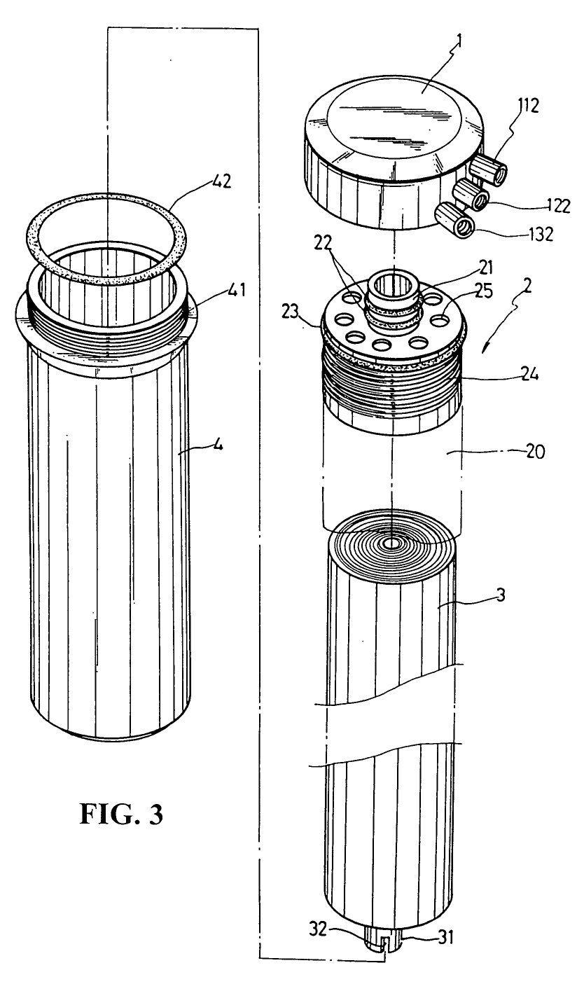

As illustrated in FIGS. 2 and 3, the reverse osmosis filtering assembly according to the present invention contains a membrane unit cover 1, an auxiliary fastening device 2, a reverse osmosis membrane unit 3, and a membrane unit housing 4. The membrane unit cover 1 is a connection device equipped with multiple tubular connectors which includes at least an inlet tube 132, an outlet tube 112, and a drain tube 122 arranged at different vertical and horizontal locations along the side of the membrane unit cover 1. For ease of reference, a position closer to the membrane unit cover 1 is said to be higher than or above or on top of a position farther from the membrane unit cover 1 hereinafter.

As shown in FIG. 3, the membrane unit 3 is a naked membrane unit which requires the auxiliary fastening device 2 so as to be joined to the membrane unit cover 1. The auxiliary fastening device 2 is a hollow cover having a plastic film 20 extended downward along the side to wrap the entire membrane unit 3 inside and to strengthen the attachment between the membrane unit 3 and the auxiliary fastening device 2. The auxiliary fastening device 2 has a protruding neck 21 on top of a body member (not numbered). Around the circumference of the neck 21, a number of plastic rings 22 are configured. The protruding neck 21 is for insertion into an inner circular wall 11 of the membrane unit cover 1 with said plastic rings 22 for air-tightness. Also around the shoulder section of the body member, there is another plastic ring 23. Beneath the plastic ring 23, the body member has screw threads 24 for fastening to an intermediate circular wall 12 of the membrane unit cover 1, with the plastic rings 23 for air-tightness.

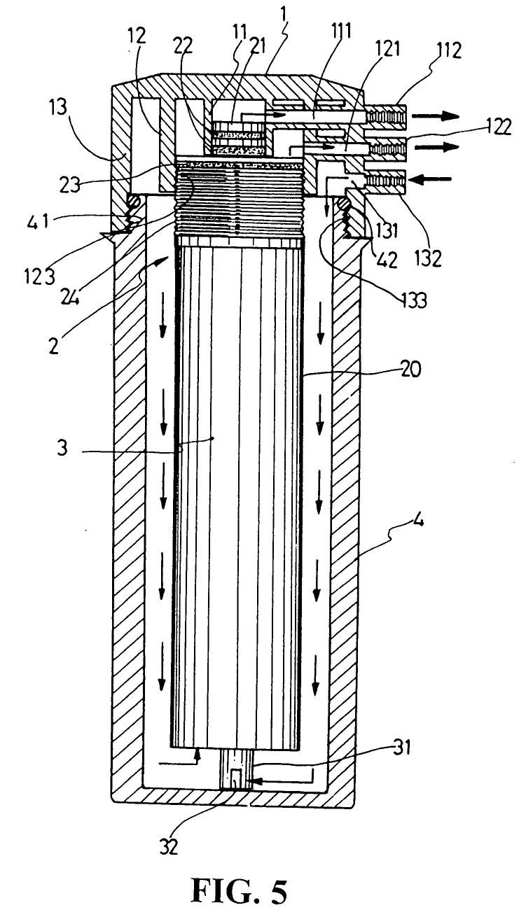

Please continue to refer to FIG. 5. As illustrated, within the membrane unit cover 1, there are multiple circular walls partitioning the inner space of the membrane unit cover 1 into several ring sections. The circular walls include at least an inner circular wall 11, an intermediate circular wall 12, and an outer circular wall 13 (which is the side of the membrane unit cover 1). The ring sections partitioned by the circular walls 11, 12, and 13 are connected to the pipes 111, 121, and 131 respectively, so as to form distinguished water passageways. As can be seen from FIG. 5, the circular walls 11, 12, and 13 are configured with different heights such that the inner circular wall 11 is shorter than the intermediate circular wall 12, which in turn is shorter than the outer circular wall 13. Therefore, correspondingly, the outlet tube 112 is arranged at a location higher than the drain tube 122, which in turn is arranged to be higher than the inlet tube 132.

The circular walls 11, 12, and 13, besides forming separate water passageways, are also used to fasten the auxiliary fastening device 2. The inner circular wall 11 accepts the protruding neck 21 of the auxiliary fastening device 2, with the plastic rings 22 around the neck 21 to form an air-tight connection. On the other hand, around the inner surface of the intermediate circular wall 12, there are screw threads 123 for fastening with the screw threads 24 around the body member of the auxiliary fastening device 2, which is sealed by the plastic ring 23 for air-tightness. Similarly, the outer circular wall 13 has screw threads 133 configured around the outer circular wall 13's inner surface, which is used for fastening with the screw threads 41 configured around the circumference of the membrane unit housing 4. The membrane unit housing 4 is also configured with a plastic ring 42 around its circumference for air-tightness.

The water purification process of the filtering assembly functions as follows. Raw water is introduced into the filtering assembly via the inlet tube 132 and then pressured into the membrane unit 3 through the membrane unit 3's bottom and the slop opening 32 on the through tube 31 at the bottom of the membrane unit 3. The purified water is then produced from the outlet tube 112 via the protruding neck 21 of the auxiliary fastening device 2. In the mean time, the waste water is expelled from the drain tube 122 via the through holes 25 configured on top of the shoulder of the auxiliary fastening device 2's body member.

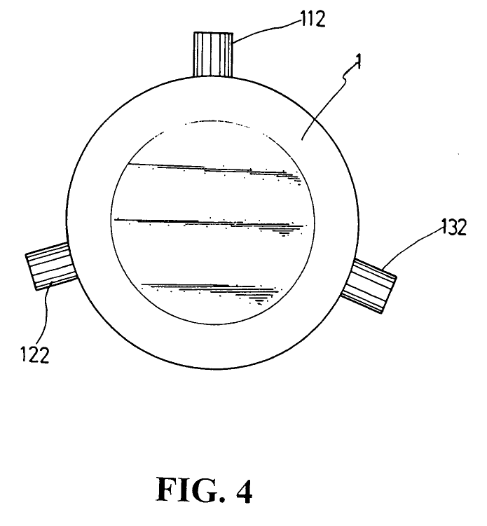

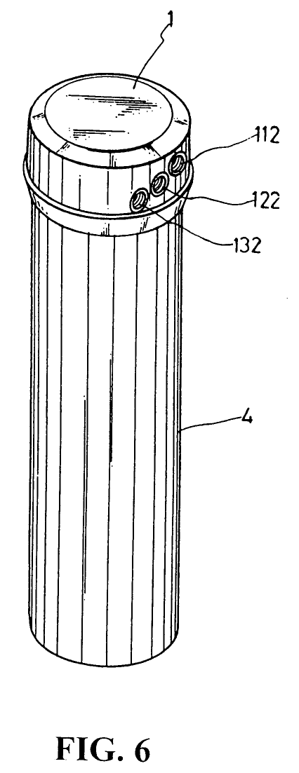

In a separate embodiment, without altering the internal structure of the membrane unit cover 1, the tubular connectors 132, 112, and 122 could be arranged evenly around the circumference of the membrane unit cover 1 as illustrated in FIG. 4. Please note that the tubular connectors 132, 112, and 122 are still at different vertical locations. In another embodiment, as shown in FIG. 6, the tubular connectors 132, 112, and 122 are configured as jacks with screw threads around the inner surfaces for connection with the corresponding pipelines.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A reverse osmosis filtering assembly for a water treatment system comprising a membrane unit cover, an auxiliary fastening device, a membrane unit, and a membrane unit housing, wherein
said membrane unit cover has a plurality of tubular connectors comprising at least an inlet tube, an outlet tube, and a drain tube, arranged at different vertical and horizontal locations along the side of said membrane unit cover, both of said intermediate and outer circular walls have screw threads configured around the inner surfaces respectively;
said membrane unit cover has a plurality of circular walls comprising at least an inner circular wall, an intermediate circular wall, and an outer circular wall configured inside said membrane unit cover partitioning the inner space of said membrane unit cover into ring sections; each of said ring sections are connected to said tubular connectors via pipes so as to form distinguished water passageways;
said auxiliary fastening device is positioned on top of said membrane unit for joining said membrane unit to said membrane unit cover, said auxiliary fastening device has a protruding neck on top of a body member, said protruding neck has at least a first plastic ring configured around the circumference of said protruding neck; said protruding neck is for insertion into said inner circular wall with said first plastic ring for air-tightness;
said auxiliary fastening device has a plurality of through holes on top of the shoulder of said body member, said body member has at least a second plastic ring and screw threads, all configured around the circumference of said body member; said screw threads of said body member is for fastening with said screw threads of said intermediate circular wall with said second plastic ring for air-tightness;
said auxiliary fastening device has a plastic film extended downward along the side of said auxiliary fastening device to wrap said membrane unit inside;
said membrane unit has a through tube at the bottom; said through tube has a slot opening for raw water to flow into said membrane unit; and
said membrane unit housing has screw threads and a third plastic ring configured around the circumference of said membrane unit housing; said screw threads of said membrane unit housing is for fastening with said screw threads configured around said outer circular wall of said auxiliary fastening device and said third plastic ring is for air-tightness.

2. The reverse osmosis filtering assembly according to claim 1, wherein the heights of said circular walls inside said membrane unit cover are configured such that said inner circular wall is shorter than said intermediate circular wall, and said intermediate circular wall is shorter than said outer circular wall.

3. The reverse osmosis filtering assembly according to claim 1, wherein the vertical locations of said tubular connectors of said membrane unit cover are arranged so that said outlet tube is higher than said drain tube, and said drain tube is higher than said inlet tube.

4. The reverse osmosis filtering assembly according to claim 1, wherein said tubular connectors of said membrane unit cover are arranged evenly around the circumference of said membrane unit cover but with different vertical locations.

5. The reverse osmosis filtering assembly according to claim 1, wherein said tubular connectors of said membrane unit cover are configured as jacks with screw threads around the inner surfaces of said tubular connectors for connection with corresponding pipelines.
